(19) United States
(12) Patent Application Publication
(10) Pub. No.: US 2015/0372299 A1
(43) Pub. Date: Dec. 24, 2015

(54) COMPOSITIONS FOR HIGH ENERGY ELECTRODES AND METHODS OF MAKING AND USE

(71) Applicant: Wildcat Discovery Technologies, Inc., San Diego, CA (US)

(72) Inventors: Bin Li, San Diego, CA (US); Jen-Hsien Yang, San Diego, CA (US); Wei Tong, Albany, CA (US)

(73) Assignees: Wildcat Discovery Technologies, Inc., San Diego, CA (US); Tianjin B&M Science and Technology Joint-Stock Co., Ltd., Tianjin (CN)

(21) Appl. No.: 14/308,690

(22) Filed: Jun. 18, 2014

(51) Int. Cl. H01M 4/525

(52) U.S. Cl. CPC H01M 4/525

(57) ABSTRACT

A material for forming an electrode represented by the formula:

Li₁₊ₓ₊ₐMn_{1-x-y-z-w}D_{w}Ni_{y}Co_{z}O_{2-δ}

where 0≦a≦0.1, 0.1≦x≦0.5, 0≦y<1, 0≦z≦0.5, 0<w≦0.5, and 0≦δ≦0.3. The material reduces the voltage fade in electrochemical cells that use lithium-rich layered oxide electrode materials.

### BACKGROUND OF THE INVENTION

The present invention is in the field of battery technology and, more particularly, in the area of improved active materials for use in electrodes in electrochemical cells.

Research into active materials for cathodes for secondary batteries has yielded several classes of active materials. One class of active materials is a type of “over-lithiated” layered oxide (OLO), a popular version of which can be represented as:

xLi₂MnO₃.(1−x)Li[MnᵢNiⱼCoₖ]O₂ (i)

where 0<x<1, l+j+k=1, and i is non-zero. Such materials are promising candidates for next generation batteries because of their high specific capacity. Two of the major drawbacks of this class of cathodes are (1) a large irreversible capacity loss along with gas generation during initial cycling and (2) voltage fade during cycling. Voltage fade does not only reduce cell energy density, but also is not acceptable from a battery management perspective.

Despite ongoing research into voltage fade in OLO materials (see, e.g., Progress Report for Second Quarter FY 2013, Applied Battery Research for Transportation (B&R No. VT-1102000)) there remains a need for OLO-type materials with improved voltage fade performance.

### BRIEF SUMMARY OF THE INVENTION

According to some embodiments of the invention, a composition and method for reducing the voltage fade of lithium-rich layered oxide materials is presented herein. A method for making the composition and methods for making and using a battery including the composition are included.

According to some embodiments of the invention, an electrode includes a material represented by Li₁₊ₓ₊ₐMn_{1-x-y-z-w}D_{w}Ni_{y}Co_{z}O_{2-δ} where 0≦a≦0.1, 0.1≦x0.5, 0≦y<1, 0≦z≦0.5, 0<w≦0.5, and 0≦δ≦0.3. D_{w} comprises Ru and Sn. The electrode can include a monoclinic phase of a material represented by Li₂MnO₃ and the monoclinic phase further can include a dopant at the Mn site. The material can be Li_{1.17}Mn_{0.4}Ru_{0.1}Sn_{0.03}Ni_{0.2}Co_{0.1}O₂.

According to some embodiments of the invention, an electrode includes a doped material formed by co-precipitation or solid-state synthesis.

### BRIEF DESCRIPTION OF SEVERAL VIEWS OF THE DRAWINGS

FIG. 1 illustrates characterization of the voltage performance as a function of cycle for several compounds, including control compounds and compounds formed according to embodiments of the present invention.

### DETAILED DESCRIPTION OF THE INVENTION

The following definitions apply to some of the aspects described with respect to some embodiments of the invention. These definitions may likewise be expanded upon herein. Each term is further explained and exemplified throughout the description, figures, and examples. Any interpretation of the terms in this description should take into account the full description, figures, and examples presented herein.

The singular terms “a,” “an,” and “the” include the plural unless the context clearly dictates otherwise. Thus, for example, reference to an object can include multiple objects unless the context clearly dictates otherwise.

The terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

The term “about” refers to the range of values approximately near the given value in order to account for typical tolerance levels, measurement precision, or other variability of the embodiments described herein.

The term “transition metal” refers to a chemical element in groups 3 through 12 of the periodic table, including scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (Db), seaborgium (Sg), bohrium (Bh), hassium (Hs), and meitnerium (Mt).

The term “poor metal” refers to the elements aluminum (Al), gallium (Ga), indium (In), thallium (Tl), tin (Sn), lead (Pb), bismuth (Bi) and polonium (Po).

A rate “C” refers to either (depending on context) the discharge current as a fraction or multiple relative to a “1 C” current value under which a battery (in a substantially fully charged state) would substantially fully discharge in one hour, or the charge current as a fraction or multiple relative to a “1 C” current value under which the battery (in a substantially fully discharged state) would substantially fully charge in one hour.

The term “OLO” refers to an over-lithiated oxide material. The general formula for OLO materials is represented by Formula (ii):

xLiMO₂.(1−x)Li₂M′O₃ (ii)

in which 0<x<1 and M is one or more metal ions with an average trivalent oxidation state, and M′ is one or more metal ions with an average tetravalent oxidation state. In some preferred instances, the range of x can be 0.3≦x≦0.9.

The term “over-lithiated NMC” refers to materials of Formula (ii) in which nickel, manganese, and cobalt are present as M′. The material represented by Formula (i) is an over-lithiated NMC. Over-lithitated NMC materials are thus a subgroup of OLO materials.

To the extent certain battery characteristics can vary with temperature, such characteristics are specified at room temperature (about 30 degrees C.), unless the context clearly dictates otherwise.

Ranges presented herein are inclusive of their endpoints. Thus, for example, the range 1 to 3 includes the values 1 and 3 as well as intermediate values.

The terms “milling” and “mixing” are used interchangeably, except in the instances where low energy mixing processes are specified. In such instances, the materials were predominantly mixed rather than milled.

In certain embodiments, an OLO material is formed in which some atomic sites are doped with at least two dopants. The dopants can be selected from transition metal, poor metals, and combinations thereof. The doping site can be a transition metal site in either phase of the OLO material.

The doped material can be prepared by suitable synthetic methods, including co-precipitation, solid-state synthesis, and the like. Non-limiting examples of synthetic methods are presented herein.

In a preferred embodiment, a transition metal and a poor metal are each doped into a transitional metal site of the OLO material. For example, Ru and Sn can be doped into Mn sites in an OLO material. The material in this preferred embodiment can have a composition according to Formula (iii):

Li₁₊ₓ₊ₐMn_{1-x-y-z-w}D_{w}Ni_{y}Co_{z}O_{2-δ} (iii)

where 0≦a≦0.1, 0.1≦x≦0.5, 0≦y<1, 0≦z≦0.5, 0<w≦0.5, and 0≦δ≦0.3. D is Ru, Sn, or combinations thereof. For example, the undoped material can have the formula Li_{1.17}Mn_{0.53}Ni_{0.2}Co_{0.1}O₂. With this starting material, dopants can be added according to suitable synthetic methods to yield doping of Ru and Sn at the Mn site. D can be further defined as being composed of D1ₚ and D2_{q}, where p+q=w as w is defined herein. In Formula (iii), a is excess lithium and thus the amount of Li is not only influenced by the value of x in the Mn site but also by the presence of an additional a amount of lithium. The formulas below represent a range of possible preferred doping levels according to Formula (iii) where 0.3≦1−x−y−z—w≦0.5 and 0.03≦w≦0.23. Further, these formulas represent a range of values for Ruₚ and Sn_{q} where q≦0.03 and p varies from 0.01 to 0.2.
Li_{1.17}Mn_{0.5}Ru_{0.01}Sn_{0.02}Ni_{0.2}Co_{0.1}O₂
Li_{1.17}Mn_{0.5}Ru_{0.02}Sn_{0.01}Ni_{0.2}Co_{0.1}O₂
Li_{1.17}Mn_{0.49}Ru_{0.01}Sn_{0.03}Ni_{0.2}Co_{0.1}O₂
Li_{1.17}Mn_{0.48}Ru_{0.02}Sn_{0.03}Ni_{0.2}Co_{0.1}O₂
Li_{1.17}Mn_{0.47}Ru_{0.03}Sn_{0.03}Ni_{0.2}Co_{0.1}O₂
Li_{1.17}Mn_{0.46}Ru_{0.04}Sn_{0.03}Ni_{0.2}Co_{0.1}O₂
Li_{1.17}Mn_{0.45}Ru_{0.05}Sn_{0.03}Ni_{0.2}Co_{0.1}O₂
Li_{1.17}Mn_{0.44}Ru_{0.06}Sn_{0.03}Ni_{0.2}Co_{0.1}O₂
Li_{1.17}Mn_{0.43}Ru_{0.07}Sn_{0.03}Ni_{0.2}Co_{0.1}O₂
Li_{1.17}Mn_{0.42}Ru_{0.08}Sn_{0.03}Ni_{0.2}Co_{0.1}O₂
Li_{1.17}Mn_{0.41}Ru_{0.09}Sn_{0.03}Ni_{0.2}Co_{0.1}O₂
Li_{1.17}Mn_{0.4}Ru_{0.10}Sn_{0.03}Ni_{0.2}Co_{0.1}O₂
Li_{1.17}Mn_{0.39}Ru_{0.11}Sn_{0.03}Ni_{0.2}Co_{0.1}O₂
Li_{1.17}Mn_{0.38}Ru_{0.12}Sn_{0.03}Ni_{0.2}Co_{0.1}O₂
Li_{1.17}Mn_{0.37}Ru_{0.13}Sn_{0.03}Ni_{0.2}Co_{0.1}O₂
Li_{1.17}Mn_{0.36}Ru_{0.14}Sn_{0.03}Ni_{0.2}Co_{0.1}O₂
Li_{1.17}Mn_{0.35}Ru_{0.15}Sn_{0.03}Ni_{0.2}Co_{0.1}O₂
Li_{1.17}Mn_{0.34}Ru_{0.16}Sn_{0.03}Ni_{0.2}Co_{0.1}O₂
Li_{1.17}Mn_{0.33}Ru_{0.17}Sn_{0.03}Ni_{0.2}Co_{0.1}O₂
Li_{1.17}Mn_{0.32}Ru_{0.18}Sn_{0.03}Ni_{0.2}Co_{0.1}O₂
Li_{1.17}Mn_{0.31}RU_{0.19}Sn_{0.03}Ni_{0.2}Co_{0.1}O₂
Li_{1.17}Mn_{0.3}Ru_{0.2}Sn_{0.03}Ni_{0.2}Co_{0.1}O₂

In other embodiments, there is a range of possible preferred doping levels according to Formula (iii) where 0.3≦1−x−y−z−w≦0.42 and 0.11≦w≦0.23 and the range of values for Ruₚ and Sn_{q} is p=0.1 and q varies from 0.01 to 0.2.
Li_{1.17}Mn_{0.42}Ru_{0.1}Sn_{0.01}Ni_{0.2}Co_{0.1}O₂
Li_{1.17}Mn_{0.41}Ru_{0.1}Sn_{0.02}Ni_{0.2}Co_{0.1}O₂
Li_{1.17}Mn_{0.4}Ru_{0.1}Sn_{0.03}Ni_{0.2}Co_{0.1}O₂
Li_{1.17}Mn_{0.39}Ru_{0.1}Sn_{0.04}Ni_{0.2}Co_{0.1}O₂
Li_{1.17}Mn_{0.38}Ru_{0.1}Sn_{0.05}Ni_{0.2}Co_{0.1}O₂
Li_{1.17}Mn_{0.37}Ru_{0.1}Sn_{0.06}Ni_{0.2}Co_{0.1}O₂
Li_{1.17}Mn_{0.36}Ru_{0.1}Sn_{0.07}Ni_{0.2}Co_{0.1}O₂
Li_{1.17}Mn_{0.35}Ru_{0.1}Sn_{0.08}Ni_{0.2}Co_{0.1}O₂
Li_{1.17}Mn_{0.34}Ru_{0.1}Sn_{0.09}Ni_{0.2}Co_{0.1}O₂
Li_{1.17}Mn_{0.33}Ru_{0.1}Sn_{0.1}Ni_{0.2}Co_{0.1}O₂
Li_{1.17}Mn_{0.32}Ru_{0.1}Sn_{0.11}Ni_{0.2}Co_{0.1}O₂
Li_{1.17}Mn_{0.31}Ru_{0.1}Sn_{0.12}Ni_{0.2}Co_{0.1}O₂
Li_{1.17}Mn_{0.33}Ru_{0.1}Sn_{0.13}Ni_{0.2}Co_{0.1}O₂

The above formulas are not intended to be limiting and merely illustrate one range of doping combinations. The present disclosure embraces the full range of possible combination of Ru and Sn that are mathematically possible given the ranges of Formula (iii).

In certain preferred embodiments, Ruₚ and Sn_{q} are chosen such that 0.01≦p≦0.3 and 0.01≦q≦0.2. In these preferred embodiments, the values for x, y and z can independently vary according to the values presented herein. For example, while y=0.2 in several of the specific examples herein, y can range from 0 to less than 1 in each of the combinations of Ruₚ and Sn_{q} where 0.01≦p≦0.3 and 0.01≦q≦0.2. Similarly, although z=0.1 in several of the specific examples herein, z can range from 0 to 0.5 in each of the combinations of Ruₚ and Sn_{q} where 0.01≦p≦0.3 and 0.01≦q≦0.2.

When considering values for y and z for the embodiments represented by Formula (iii), y and z should be choses such than one of them is non-zero. Further, the minimum amount for w is 0.01. The benefits of the invention are most readily observed in OLO materials with a pronounced voltage fade. That is, when x, y, and z are chosen to yield an OLO material with a comparatively larger voltage fade, the doping can significantly improve the OLO material. Thus, in some OLO materials the improvement via doping will not be comparatively large if the voltage fade of the undoped material is not that large to begin with,

Advantageously, the doped materials disclosed herein maintain the crystal structure of the undoped OLO material. OLO materials can be thought of as a composite or a solid solution. In an over-lithiated NMC, the components of the composite or solid solution are a monoclinic phase and a layered oxide phase.

The monoclinic phase is composed of Li₂MnO₃ and the layered oxide phase is composed of Li[NiₐMn_{b}Co_{c}]O₂ where 0<a and c≦0.5, (although a and c cannot each be zero at the same time; that is, there is always either Ni or Co present) while b varies with the level of doping. The resulting over-lithiated NMC can be represented as Li₂MnO₃.Li[NiₐMn_{b}Co_{c}]O₂.

The preferred doped materials disclosed herein maintain a monoclinic phase and a layered oxide phase in the doped over-lithiated NMC material. A monoclinic phase exists for both Ru and Sn, namely Li₂RuO₃ and Li₂SnO₃, and the monoclinic phase of the over-lithiated NMC material is composed of Li₂MnO₃. Thus, a preferred doping site of Ru or Sn in an over-lithiated NMC material would be the Mn site in the monoclinic phase. Indeed, to the extent any OLO material includes a monoclinic Mn-containing phase then Ru or Sn may preferentially be doped into that phase. That is, this doping phenomenon is not limited to over-lithitated NMC but could be applied to OLO materials with layered oxide phases with other constituents. The examples herein demonstrate the particular suitability of Ru and Sn with over-lithitated NMC materials.

Without being bound by particular theories or mechanisms of action, improved stability of the monoclinic phase from doping can mitigate voltage fade by reducing the phase transformation from the monoclinic phase to the spinel phase. Indeed, data presented herein demonstrates an extremely low voltage fade for a purely monoclinic material, namely Li_{2.1}RuO₃. The compositions of the present invention can improved the voltage fade of OLO materials while retaining the other favorable performance and commercial attributes of OLO materials, and in particular over-lithitated NMC materials.

The voltage fade in OLO materials can be measured over several cycles. Certain prior art OLO materials have shown a voltage fade on charging of about 9.5 mV per cycle and a voltage fade on discharge of about 6 mV per cycle. Embodiments disclosed herein provide significant improvement over the prior art OLO materials.

The following examples describe specific aspects of some embodiments of the invention to illustrate and provide a description for those of ordinary skill in the art. The examples should not be construed as limiting the invention, as the examples merely provide specific methodology useful in understanding and practicing some embodiments of the invention.

### EXAMPLES

Materials and Synthetic Methods. The lithium rich layered oxide material is prepared via a co-precipitation process. Metal nitrates are used as Li, Mn, Ni, Co, Ru and Sn precursors. The as-received precursors from commercial sources are dissolved in deioninzed water and the stoichiometric metal nitrate solutions are first mixed together for the target composition, then NH₄HCO₃ solution is added slowly to the mixed metal nitrate solution as the co-precipitation. After mixing for 0.5 hours, the solutions are dried at 60 degrees C. for overnight, then heated up to 200 degrees C. for 3 hours and annealed at 900 degrees C. for 10 hours. Both drying and annealing process are performed under air atmosphere. Ru and Sn metal powder can also be used as doping sources, as opposed to the metal nitrates.

Electrode Formulation. Cathodes based on the activated layered oxide material were prepared using a formulation composition of 80:10:10 (active material:binder:conductive additive) according to the following formulation method. 198 mg PVDF (Sigma Aldrich) was dissolved in 11 mL NMP (Sigma Aldrich) overnight. 198 mg of conductive additive was added to the solution and allowed to stir for several hours. 144 mg of the activated layered oxide material was then added to 1 mL of this solution and stirred overnight. Films were cast by dropping about 50 mL of slurry onto stainless steel current collectors and drying at 150 degrees C. for about 1 hour. Dried films were allowed to cool, and were then pressed at 1 ton/cm². Electrodes were further dried at 150 degrees C. under vacuum for 12 hours before being brought into a glove box for battery assembly.

Electrochemical Characterization. All batteries were assembled in a high purity argon filled glove box (M-Braun, O₂ and humidity contents <0.1 ppm), unless otherwise specified. Cells were made using lithium as an anode, Celgard 2400 separator, and 90 mL of 1M LiPF₆ in 1:2 EC:EMC electrolyte. Electrodes and cells were electrochemically characterized at 30 degrees C. with a constant current C/10 charge and discharge rate between 4.8 and 2.0 V for the first two cycles. Starting from cycle 4, both charge and discharge rate is C/2 with slow rate C/10 on every 25^{th} cycle between 4.8 and 2 V.

### RESULTS

Table 1 shows the results of voltage fade characterization for certain materials. Table 1 shows the measured capacity for the material, the peak voltage at cycle 2, and the voltage fade from cycle 2 to cycle 50. The materials in Table 1 include a control over-lithiated NMC material (Li_{1.7}Mn_{0.53}Ni_{0.2}Co_{0.1}O₂), an over-lithiated NMC material doped with Ru only (Li_{1.17}Mn_{0.43}Ru_{0.1}Ni_{0.2}Co_{0.1}O₂), an over-lithiated NMC material doped with Ru and Sn (Li_{1.17}Mn_{0.4}Ru_{0.1}Sn_{0.03}Ni_{0.2}Co_{0.1}O₂), and a monoclinic phase of Li_{2.1}RuO₃. Both the non-doped and Ru-doped OLO materials showed voltage fade of about 0.28V from cycle 2 to cycle 50. The Ru and Sn double doped OLO showed smaller voltage fade of about 0.18V.

TABLE 1
Data for a conventional OLO compared to doped
OLOs and a monoclinic phase material.

| | Capacity | Cy2 Vol. | dV_{(Cy2-Cy50)} |
|---|---|---|---|
| Compounds | (mAh/g) | Peak (V) | (V) |
| Li_{1.17}Mn_{0.53}Ni_{0.2}Co_{0.1}O₂ | 268 | 3.308 | 0.28 |
| Li_{1.17}Mn_{0.43}Ru_{0.1}Ni_{0.2}Co_{0.1}O₂ | 254 | 3.344 | 0.28 |
| Li_{1.17}Mn_{0.4}Ru_{0.1}Sn_{0.03}Ni_{0.2}Co_{0.1}O₂ | 255 | 3.346 | 0.18 |
| Li_{2.1}RuO₃ | 251 | 3.304 | 0.01 |

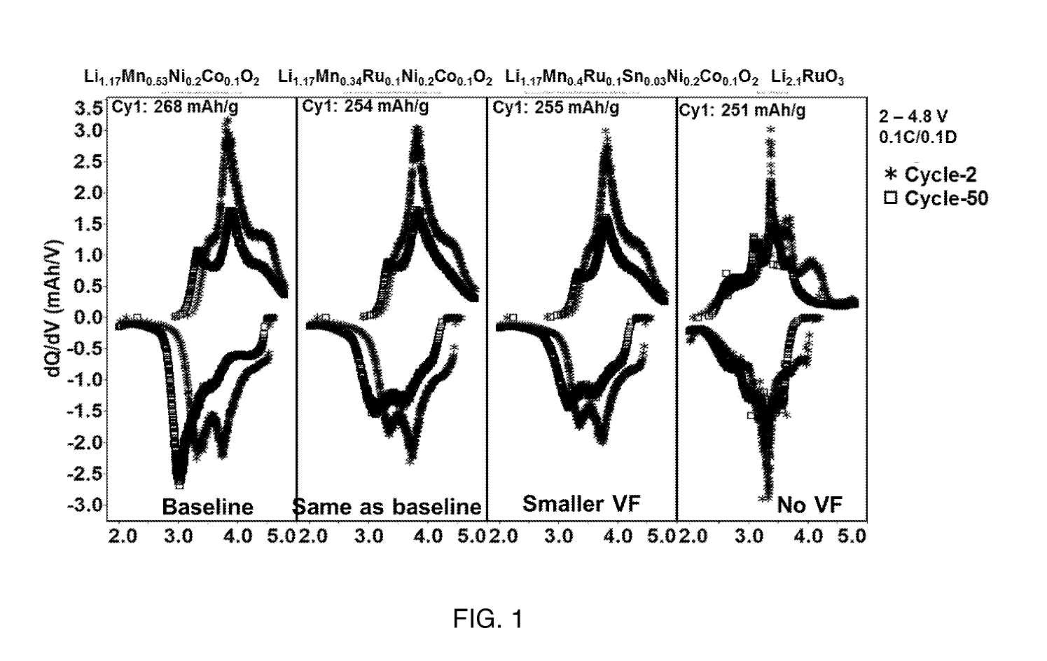

FIG. 1 illustrates a voltage trace comparison between cycle 2 and cycle 50 for the materials in Table 1. As compared to the control undoped material, a smaller voltage fade on discharging around 3V is observed for the Ru and Sn double doped materials. Almost no voltage fade is seen for the Li_{2.1}RuO₃ material.

Embodiments disclosed herein rely on doping certain elements into OLO materials, and specifically into over-lithiated NMC materials. Generally speaking, doping is a known technique. Yet, the relevant prior art does not disclose the doping described herein. For example, Chinese Patent Publication 102881894 discloses a method for preparing a lithium-enriched solid solution cathode material by doping iron, copper and tin ions but does not disclose the use of Ru. Also regarding Sn, U.S. Pat. No. 7,678,503 discloses the use of Sn salt precursors for surface modification of an OLO material but does not disclose the use of Ru and is not about doping.

Regarding Ru, it has been suggested that OLO materials may benefit from the presence of trace amount of Ru (see, e.g., B. Song et al., “Influence of Ru substitution on Li-rich 0.55Li2MnO3.0.45LiNi1/3Co1/3Mn1/3O2 cathode for Li-ion batteries,” Electrochimica Acta 80 (2012) 187-195.) However, the discussion focuses on the use of Ru alone and in trace amounts. Also, Li₂Ru_{1-y}Mn_{y}O₃ (0.2≦y≦0.8) has been investigated as a cathode material, but not in combination with Sn (See, M. Sathiya et al., “High Performance Li₂Ru_{1-y}Mn_{y}O₃ (0.2≦y≦0.8) Cathode Materials for Rechargeable Lithium-Ion Batteries: Their Understanding,” Chem. Mater. 2013, 25, 1121-1131.)

However, the embodiments disclosed herein perform in a manner unexpected in view of the prior art and in view of the singly doped materials tested. The double doped OLO demonstrates improvement that unexpectedly approaches the performance of the Li_{2.1}RuO₃ material. Yet, the Ru doped material does not show any improvement in performance. It is unexpected that the addition of a poor metal like Sn would bridge the performance gap between an Ru-doped OLO and a Li_{2.1}RuO₃ material.

Further, while it may be expected from the literature that Ru doping may help preserve the monoclinic phase, it is not expected that the addition of Sn to an Ru-doped system would improve the preservation of the monoclinic phase and prevent transformation of this monoclinic phase to the spinel phase. Both the improvement itself, when comparing double doped OLO to singly doped OLO, and the magnitude of the improvement are unexpected.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

1. An electrode within a battery, comprising:
a material represented by Li₁₊ₓ₊ₐMn_{1-x-y-z-w}D_{w}Ni_{y}Co_{z}O_{2-δ} where 0≦a≦<0.1, 0.1≦x≦0.5, 0≦y<1, 0≦z≦0.5, 0<w≦0.5, and 0≦δ≦0.3, the material comprising a monoclinic phase and a layered oxide phase;
wherein D_{w} comprises Ru and Sn and wherein one of y or z is non-zero and the monoclinic phase is represented by Li₂MnO₃ and comprises a dopant at a Mn site of the monoclinic phase; and
wherein the battery is characterized by reduced voltage fade as compared to a control battery comprising a control electrode formed from a control material represented by Li₁₊ₓ₊ₐMn_{1-x-y-z-w}D_{w}Ni_{y}Co_{z}O_{2-δ} where 0≦a≦0.1, 0.1≦x≦0.5, 0≦y<1, 0≦z≦0.5, and 0≦δ≦0.3.

2. The electrode of claim 1 wherein D_{w} comprises Ruₚ and Sn_{q}. where p+q=w.

3. The electrode of claim 2 wherein 0.01≦p<0.5.

4. The electrode of claim 2 wherein 0.01≦p≦0.3.

5. The electrode of claim 2 wherein 0.05≦p≦0.15.

6. The electrode of claim 2 wherein 0.01≦q<0.5.

7. The electrode of claim 2 wherein 0.01≦q≦0.2.

8. The electrode of claim 2 wherein 0.01≦q≦0.05.

9.-10. (canceled)

11. The electrode of claim 1 wherein the dopant at a Mn site of the monoclinic phase is Ru.

12. The electrode of claim 1 wherein the dopant at a Mn site of the monoclinic phase is Sn.

13. The electrode of claim 1 wherein z=0.1.

14. The electrode of claim 1 wherein y=0.2.

15. The electrode of claim 1 wherein the material comprises Li_{1.17}Mn_{0.4}Ru_{0.1}Sn_{0.03}Ni_{0.2}Co_{0.1}O₂.

16. The electrode of claim 1 wherein the material is formed by co-precipitation.

17. The electrode of claim 1 wherein the material is formed by solid-state synthesis.

18. A The battery comprising the electrode of claim 1.

19. The electrode of claim 1 wherein the monoclinic phase comprises multiple dopants at multiple Mn sites of the monoclinic phase and the dopants include both Ru and Sn.
